(19) United States
(12) Patent Application Publication
(10) Pub. No.: US 2007/0205964 A1
(43) Pub. Date: Sep. 6, 2007

(54) PLASMA DISPLAY PANEL DISPLAY DEVICE

(75) Inventor: Toshikazu Nagaki, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/599,841

(22) PCT Filed: Mar. 25, 2005
(86) PCT No.: PCT/JP05/05533

§ 371 Date: Feb. 27, 2007

(30) Foreign Application Priority Data
Apr. 12, 2004 (JP) 2004/116520

(51) Int. Cl. G09G 3/28

(52) U.S. Cl. 345/60

(57) ABSTRACT

A plasma display panel (PDP) display device is provided, which can reduce the power consumption in the PDP display device without lowering of the display luminance of the PDP and has excellent reliability in suppressing rise of temperature. The PDP display device has a PDP (1) having a plurality of electrodes, a drive circuit (2) for supplying a driving waveform to the electrode, a power supply circuit (3) for supplying a power to the drive circuit, and a power control circuit (4) for adjusting an output power which can be supplied to an electrode of a plasma display panel by controlling a stop period of the power supply circuit based on emission state of the plasma display panel.

### TECHNICAL FIELD

The present invention relates to a low-power technique of an electric circuit used for a plasma display panel display device.

### BACKGROUND ART

As a panel for color display, a plasma display panel (hereinafter, referred to as “PDP”) has been produced on a commercial basis. FIG. 20 is a view showing arrangement of an electrode and a structure of a drive circuit of a three-electrode AC type PDP in a conventional creeping discharge, which has been produced on a commercial basis (for example, refer to a non-patent document 1).

As shown in FIG. 20, the three-electrode AC type PDP has a configuration in which electrodes serving as a positive electrode or a negative electrode (referred to as an X electrode, a Y electrode, or a sustain electrode) are arranged on a substrate at a front side in parallel and an address electrode is arranged on a substrate at a rear face side so as to intersect with a pair of sustain electrodes. Each intersecting point of the electrodes is a discharge cell to be addressed. An X drive circuit to generate a sustain pulse waveform is connected to a sustain electrode and a Y drive circuit is also connected to the sustain electrode via a scan driver for selection of a scan pulse. An address circuit to generate an address waveform is also connected to the address electrode via an address driver to select an emitting cell.

Since the PDP only can control emission in two states of emission/non-emission, in order to achieve gray scale display, a plurality of two-valued images (subfields) having different weightings of luminance are displayed sequentially to provide one image (one field) by an integral effect of an eyesight.

FIG. 21 is a view showing an example of a driving waveform to be applied to each electrode during a subfield period described in the non-patent document 1. There are a reset period for applying a reset waveform to write and erase all discharge cells, an address period for applying an address waveform to write the data in the selected discharge cell, and a sustain period for applying a sustain waveform to sustain and discharge the selected and written discharge cell.

Voltages with various amplitudes and different pulse widths required for each period are applied to each electrode. For example, according to the example of FIG. 21, during the reset period, synchronous pulses including a pulse of 60V and a pulse of 360V are applied to the address electrode and the X electrode, respectively. During the address period, a pulse of 60V is applied to the address electrode and a pulse with −170V peak synchronized with each of the address electrode pulses is applied to each Y electrode, respectively, being superimposed into a pulse voltage of −70V. In addition, during the address period, the voltage of 50V is applied to the X electrode. During the sustain period, a pulse of 60V is applied to the address electrode and a pulse of 180V is alternately applied to the X electrode and the Y electrode. Thus, in order to apply various pulse voltages, a plurality of power supply circuits are provided. Depending on the number of pulses during the sustain period of this subfield, the luminance is weighted. An emission time becomes linger and the luminance becomes higher as the number of pulses becomes more. One field is configured by 8 to 10 subfields having different number of pulses capable of being emitted during the subfield period.

FIG. 22 is a block diagram of a drive circuit for generating a driving waveform described in the non-patent document 1, from RGB image data. An RGB signal is stored in a frame memory once and then transferred to an address driver in accordance with the addressing operation of each subfield by an I/O buffer. A control signal to a scan side is made at the same time to be transferred to a driver at a Y side at a synchronous timing. An X sustain pulse is directly applied to each electrode, a Y sustain pulse is applied to each electrode via a scan driver, and the address pulse is applied to each electrode via the address driver to display an image.

Particularly, in recent years, increase in the number of pixel has been progressed due to a large screen and a high degree of precision of a PDP display device. However, in accordance with the progress, an electric power to be consumed for discharge in a panel and a drive circuit has been also increased. Therefore, various technologies to reduce power consumption in the PDP display device have been proposed.

For example, a patent document 1 describes a PDP display device includes a plasma display panel, a plurality of row drivers and column drivers, a high voltage and high frequency oscillation circuit, and a power supply unit. The plasma display panel includes a plurality of row electrodes and a plurality of columns. The row driver and column driver activate row and column electrodes in accordance with row and column selection signals. The high voltage and high frequency oscillation circuit supplies two phases of high voltage and high frequency pulses, which are opposite phases each other, to the row and column drivers. The power supply unit supplies electric power to the high voltage and high frequency oscillation circuit. In the PDP display device, an electric current sensor is provided in the middle of a power supply line from a power supply unit to the high voltage and high frequency oscillation circuit so as to be capable of varying an oscillation frequency of the high voltage and high frequency oscillation circuit by the output of an electric current sensor.

According to the PDP display device described in the patent document 1, a sensor provided between the power supply unit and the high voltage and high frequency oscillation circuit detects amount of electric current flowing from the power supply unit. Therefore, when the number of displayed characters on the PDP is increased, a load current is increased, and the supply current to the high voltage and high frequency oscillation circuit is increased, the oscillation frequency of the high voltage and high frequency oscillation circuit is reduced. Therefore, the load current to the plasma display panel is reduced and the amount of electric current flowing from the power supply unit is made constant, suppressing increase in the electric power.

Patent Document 1: JP-A-56-119191 (refer to all pages and FIGS. 1 and 2)

Non-Patent Document 1: Tatsuo Uchida et al., “Flat Panel Display Dictionary”, debut in Dec. 25, 2001, by Kabushiki Kaisha Kogyo Chosakai, (P. 612, FIGS. 1 and 2, PP. 613 to 614, FIG. 1)

### DISCLOSURE OF INVENTION

### Problems to be Solved by the Invention

According to the above-described conventional configuration, since frequency of the high voltage and high frequency pulse to be applied to the PDP is lowered, a displayed luminance is decreased. In the PDP of a character display type which is an example to which a conventional structure is applied, it is very rare to display characters on the all areas of a screen and lowering of the displayed luminance is not a problem in practice. However, in the PDP to display a color still picture or a color moving picture or the like on the all areas of the screen, lowering of the displayed luminance is a serious problem in an image quality.

The present invention is directed to solve the above-described problem and the object of the present invention is to provide a PDP display device for reducing a power consumption without decrease of the displayed luminance.

### Solving Means

According to a first aspect of the invention, a plasma display panel display device includes a plasma display panel having a plurality of electrodes; a drive circuit that supplies a driving waveform to the electrode; a power supply circuit that supplies a power to the drive circuit; and a power control circuit that adjusts an output power which can be supplied to an electrode of a plasma display panel, by controlling a non-operational (stop) period of the power supply circuit based on emission state of the plasma display panel. According to this configuration, based on a light emission state of the plasma display panel, it is possible to limit an operational period of a power supply circuit into the bare essential operation period at that time, and an electric power to be consumed in the power supply circuit can be reduced.

The power control circuit may adjust an output power based on a ratio between the non-operational (stop) period and the operational period of the power supply circuit.

In addition, when the power supply circuit is configured in a switching system, one period (cycle) including the non-operational period and the operational period of the power supply circuit controlled by the power control circuit may be longer than one period (cycle) of the switching operation of the power supply circuit.

In addition, in the case of configuring the power supply circuit in a switching system, the operation and stop of the power supply circuit by the power control circuit may be repeated at a random frequency. According to this structure, it is possible to prohibit generation of a sound due to repetition of stop and operation of the power supply circuit by the power control circuit.

In addition, in the case of configuring the power supply circuit in a switching system, the operation and stop of the power supply circuit by the power control circuit is repeated at a constant frequency. In this case, it is preferable that a repetition frequency of the operation of the power supply circuit and stop of the operation by the power control circuit is not less than an audible frequency. According to this structure, it is possible to prohibit generation of a sound due to repetition of stop and operation of the power supply circuit by the power control circuit.

In the above-described case, the repetition frequency of the operation and stop of the power supply circuit by the power control circuit may be synchronized with a driving frequency of the power supply circuit. Further, the repetition frequency of the operation and stop of the power supply circuit by the power control circuit may be 1/n of a driving frequency of the power supply circuit (n is a positive integer).

In addition, the power supply circuit may include a transformer or inductor, a switch to intermittently apply a power supply voltage to the transformer or inductor, a switch driver for driving the switch, and a controller that controls the switch driver. In this case, the power control circuit includes a drive stop circuit for stopping the switch driver in order to stop the power supply circuit based on emission state of the plasma display panel.

In addition, the power control circuit may adjust the output power on the basis of the video information to be displayed.

Further, the power control circuit may adjust the output power on the basis of the number of data pulses which are included in an address period.

Further, the power control circuit may adjust the output power on the basis of the output current of a power supply circuit for driving a data pulse.

Further, the power control circuit may adjust an output power on the basis of the video information to be displayed, which is stored in a frame memory.

The power supply circuit may be configured in a resonance system or a regenerative system.

According to a second aspect of the invention, the PDP display device includes a plasma display panel having a plurality of electrodes; a drive circuit for supplying a driving waveform corresponding to each of a plurality of control periods to the electrode; a plurality of power supply circuits for supplying electric power to the drive circuit; and an electric power control circuit for stopping, in each control period, power supply circuits which are not necessary for generation of driving waveforms to be supplied to electrodes of the plasma display panel during the period, among the plurality of power supply circuits. According to the structure, during a certain control period, it is possible to reduce the power to be consumed in the power supply circuit by stopping the power supply circuit which does not contribute to a waveform applied to the plasma display panel during the period.

In the second aspect, the power supply circuit may include a transformer or an inductor; a switch to intermittently apply a power supply voltage to the transformer or inductor; a switch driver to drive a switch; and a controller to control the switch driver. The power control circuit may stop the switch driver in order to stop the power supply circuit.

In the second aspect, the power control circuit may stop the operation of the power supply circuit in synchronization with a reset period, an address period, a sustain period, or a subfield cycle or a field cycle.

### Effects of the Invention

According to the present invention, the plasma display panel display device stops the power supply circuit for each control period, which is not necessary for waveform to be supplied to each electrode during the control period. Due to the stop, it is possible to reduce the power consumption in the power supply circuit. Alternatively, based on a light emission state of the plasma display panel, it is possible to limit an operational period of a power supply circuit to the bare essential operation period at that time and an electric power to be consumed within the power supply circuit can be reduced. In addition, it is possible to prohibit generation of a sound due to repetition of stop and operation of the power supply circuit by the power control circuit. As described above, the present invention can realize the plasma display panel display device capable of decreasing power consumption without decrease of the displayed luminance.

### BRIEF DESCRIPTION OF DRAWINGS

FIG. 1 is a block diagram of a PDP display device of a first embodiment according to the present invention.

FIG. 2 is a block diagram showing detailed configurations of a power supply circuit and a power control circuit among a power supply circuit group.

FIG. 3A is a view showing specific circuit examples of a stop circuit of a control circuit for an unnecessary period and a control circuit, for a power supply circuit necessary for an address period.

FIG. 3B is a view showing output signal waveforms of a signal for a reset period, a signal for an address period, output of an OR gate, an emitter voltage of a transistor, and an output signal of a control circuit in the configuration shown in FIG. 3A ((a) a signal for a reset period, (b) a signal for an address period, (c) output of an OR gate 401a, (d) an emitter output of a transistor 401b, (e) an output signal (S) of a control circuit 302, and (f) a control signal (So)).

FIG. 4 is a view showing waveforms of a voltage and current of a switch, and a secondary winding current of a transformer when the power supply circuit necessary for the address period has a ringing chalk converter (RCC) structure according to the respective operations of the conventional art and the present invention ((a) a voltage of a conventional switch 304; (b) a current of the conventional switch 304; (c) a secondary winding current of a conventional transformer 305; (d) the voltage of the switch 304 of the present invention, (e) the current of the switch 304 of the present invention, and (f) the secondary winding current of the transformer 305 of the present invention).

FIG. 5 is a view showing specific configurations of a power supply circuit and a power control circuit of a PDP display device according to a second embodiment of the present invention.

FIG. 6A is a view showing specific configuration examples of a drive stop circuit for unnecessary period and a drive circuit, for a power supply circuit necessary for an address period.

FIG. 6B is a view showing output signal waveforms of a signal for an address period, an output signal of a control circuit, output of an AND gate, and an output signal of a drive circuit in FIG. 6A ((a) a signal for an address period, (b) an output signal of a control circuit 302, (c) output of an AND gate 402a, and (d) output signal of a drive circuit 303).

FIG. 7 is a view showing waveforms of a voltage of a switch, a current of the switch, and a secondary winding current of a transformer when the power supply circuit necessary for the address period has RCC structure according to the respective operations of the conventional art and the present invention ((a) a voltage of a conventional switch 304; (b) a current of the conventional switch 304; (c) a secondary winding current of a conventional transformer 305; (d) a voltage of the switch 304 of the present invention, (e) a current of the switch 304 of the present invention, and (f) the secondary winding current of the transformer 305 of the present invention).

FIG. 8 is a block diagram showing specific configurations of a power supply circuit and a power control circuit when the power supply circuit has a current resonance circuit configuration in a PDP display device according to another example of the second embodiment of the present invention.

FIG. 9 is a view showing waveforms of a primary winding current and a secondary winding current of a transformer when the power supply circuit necessary for the sustain period has a half bridge current resonance circuit configuration according to the respective operations of the conventional art and the present invention ((a) primary winding current of a conventional transformer 305; (b) a secondary winding current of the conventional transformer 305; (c) the secondary winding current of the conventional transformer 305; (d) the primary winding current of a transformer 305 according to the present invention, (e) the secondary winding current of the transformer 305 according to the present invention, and (f) the secondary winding current of the transformer 305 according to the present invention).

FIG. 10 is a block diagram of a PDP display device according to a third embodiment of the present invention.

FIG. 11 is a block diagram showing detailed configurations of a power supply circuit and a power control circuit.

FIG. 12A is a view showing specific circuit examples of a drive stop circuit for power control and a drive circuit.

FIG. 12B is a view showing input and output properties of an n-V conversion circuit.

FIG. 13 is a view showing waveforms of a signal for an address period, a drive signal of an address driver, an output signal of a period hold circuit, an output signal of a comparator, an output signal of a control circuit, an output signal of an AND gate and an output signal of a drive circuit for one cycle of power control ((a) a signal for an address period, (b) a drive signal of an address driver 5b, (c) an output signal of a period hold circuit 403b, (d) an output signal of a comparator 403d, (e) an output signal of a control circuit 302, (f) an output signal of an AND gate 403e for one cycle of power control, and (g) an output signal of a drive circuit 303 for one cycle of power control).

FIG. 14 is a view showing a specific example of a synchronous circuit using a frequency divider.

FIG. 15 is a view showing asynchronous and synchronous waveforms of a current of the switch 304 ((a) an output signal of a control circuit 302, (b) an output signal of a comparator 403d upon an asynchronous time, (c) a current of the switch 304 upon a synchronous time, (d) an output signal of a comparator 403d upon a synchronous time, and (e) a current of the switch 304 upon a synchronous time).

FIG. 16A is a view showing specific configuration examples of a circuit for stopping driving for controlling power and a drive circuit according to other example of the PDP display device of the third embodiment.

FIG. 16B is a view showing input and output properties of an output current—V conversion circuit;

FIG. 17 is a view showing waveforms of an output current of a power supply circuit for driving a data pulse, an output signal of an output current—V conversion circuit, an output signal of a comparator, an output signal of a control circuit, an output signal of an AND gate for one cycle for power control, and an output signal of a drive circuit ((a) an output current of a power supply circuit for driving a data pulse, (b) an output signal of an output current—V conversion circuit 403f, (c) an output signal of a comparator 403d, (d) an output signal of a control circuit 302, (e) an output signal of an AND gate 403e for one cycle for power control, and (f) an output signal of a drive circuit 303 for one cycle of power control).

FIG. 18 is a view showing the structure of other configuration of the PDP display device according to the third embodiment.

FIG. 19A is a view showing specific configuration examples of a drive stop circuit for power control and a drive circuit.

FIG. 19B is a view showing input and output properties of a lighting ratio-V conversion circuit shown in FIG. 19A;

FIG. 20 is a view showing the structures of the arrangement of a panel electrode and a drive circuit of a three-electrode AC type PDP in a conventional creeping discharge.

FIG. 21 is a view showing an example of a drive waveform to be applied to each electrode during a conventional subfield period.

FIG. 22 is a block diagram of a three-electrode AC type PDP in a conventional creeping discharge.

### DESCRIPTION OF REFERENCE SINGS

1: plasma display panel (PDP)
2: drive circuit
3: power supply circuit group
3a, 3b, 3c, 3x: power source circuit
4; power control circuit
5a: scan driver
5b: address driver
6: video processing circuit
6a: video processing section
6b: frame memory;
6c: I/O buffer
7: lighting ratio-calculating circuit;
401: stop circuit of a control circuit for an unnecessary period
402: drive stop circuit for an unnecessary period
403: drive stop circuit for power control

### BEST MODE FOR CARRYING OUT THE INVENTION

With reference to the attached drawings, a first embodiment of a PDP display device according to the present invention will be described below.

### First Embodiment

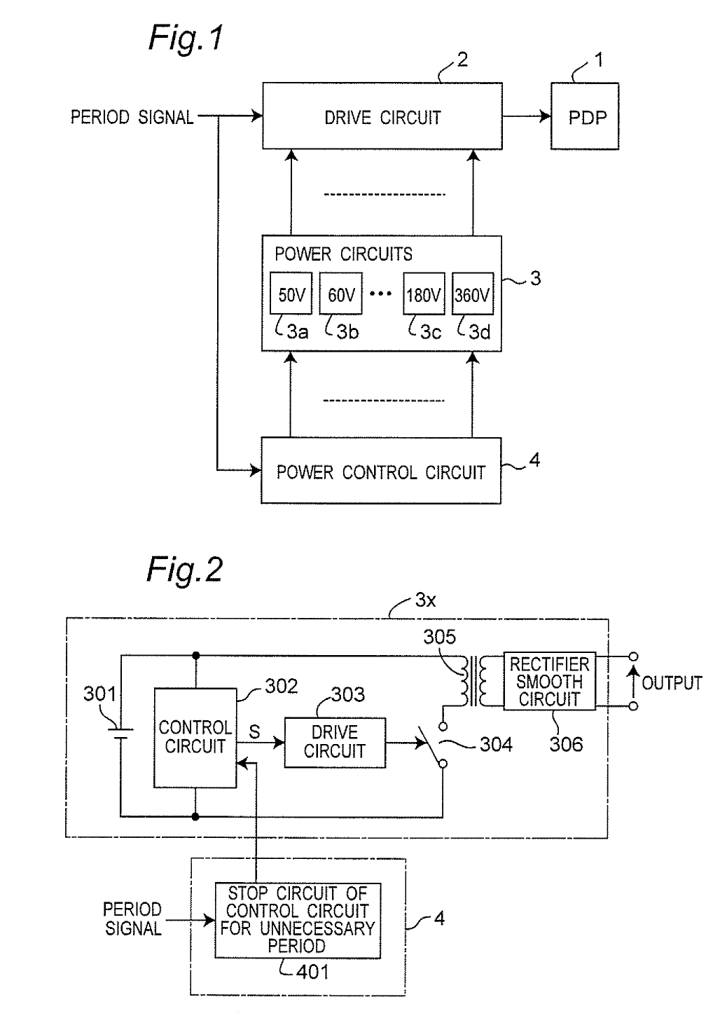

With reference to FIGS. 1 to 4, the first embodiment of the PDP display device according to the present invention will be described below.

FIG. 1 is a block diagram of a PDP display device according to the present embodiment. The PDP display device includes a PDP (a plasma display panel) 1 having a plurality of electrodes, a drive circuit 2 for generating a driving waveform corresponding to a predetermined control period and applying it to the electrode of the PDP 1, a power supply circuit group 3 for supplying powers to the PDP 1 via the drive circuit 2, and a power control circuit 4 for operating and stopping the power supply circuit group 3 according to a period signal.

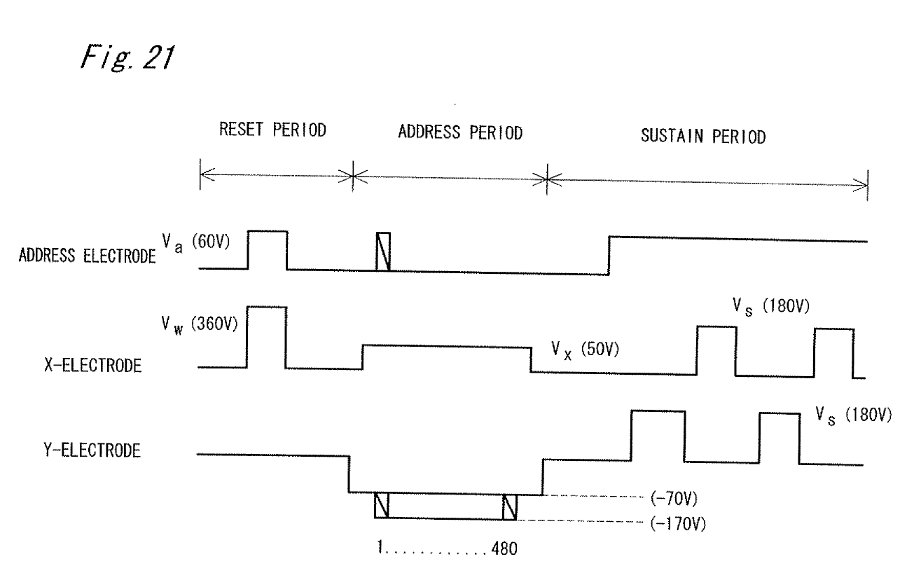

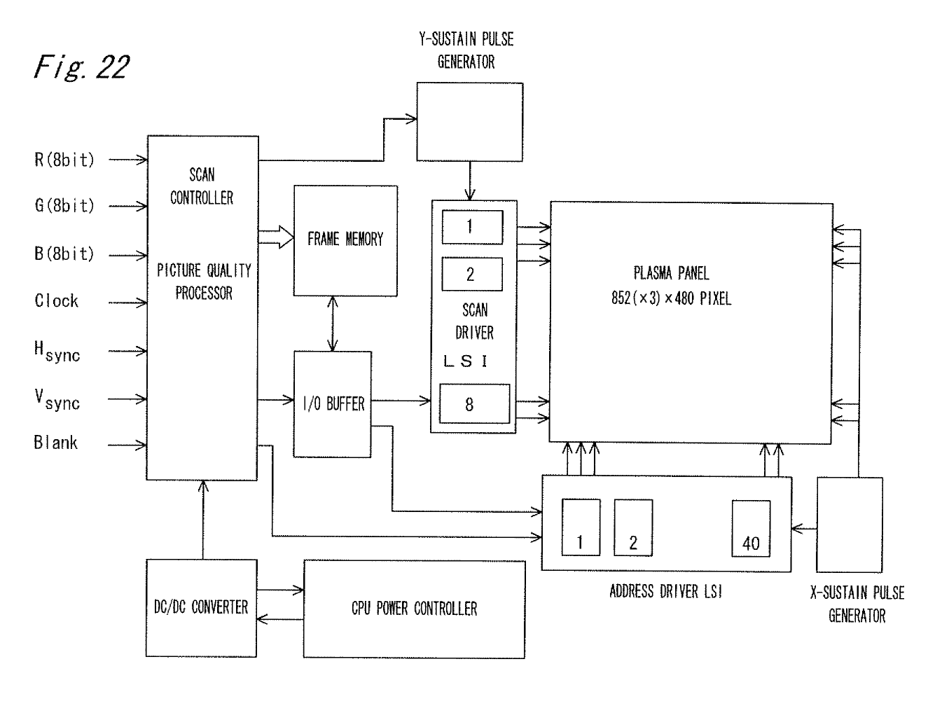

Several kinds of power supply circuits are required in order to configure the driving waveform as shown in FIG. 21, the power supply group 3 may include a plurality of power supply circuits 3a, 3b, . . . to generate different voltages, respectively. For example, a power supply circuit 3a generates a voltage of 50V, a power supply circuit 3b generates a voltage of 60V, and a power supply circuit 3c generates a voltage of 180V, respectively. The power of each power supply circuit varies from several Watt to several hundreds Watt depending on a waveform and a panel size of each associated period. Preferably each power supply circuit is of switching-type in view of a standpoint of shape and power consumption.

According to the present embodiment, among a plurality of power supply circuits in the power supply group 3, the power supply circuit which is required for each period, namely, a reset period, an address period, and a sustain period, may be only operated.

FIG. 2 is a block diagram showing detailed configurations of a power supply circuit and a power control circuit 4 among the power supply circuit group 3. The configuration shown in FIG. 2 can be applied to respective power supply circuits 3a, 3b, . . . with a reference sign “3x” naming generically “3a”, “3b”, . . . As shown in FIG. 2, a power supply circuit 3x is of a switching type. Turning on and off a voltage of a DC voltage source 301 by a switch 304 and applying it to a primary winding of a transformer 305, the power supply circuit 3x generates an AC pulse voltage on the secondary winding of the transformer 305 and converts it into a desired DC voltage by a rectifier smooth circuit 306. The DC voltage to be outputted is determined by a ratio of the number of windings of the transformer 305 and a ratio of ON and OFF of the switch 304. A drive circuit 303 to turn on and off the switch 304 is driven by an output pulse (S) of a control circuit 302.

The power control circuit 4 includes a stop circuit 401 of a control circuit for an unnecessary period. The stop circuit 401 outputs a control signal to a power supply circuit which does not contribute to formation of a waveform to be applied to an electrode of a PDP 1 during a certain control period (an address period or the like), so as to stop the power supply circuit during the control period.

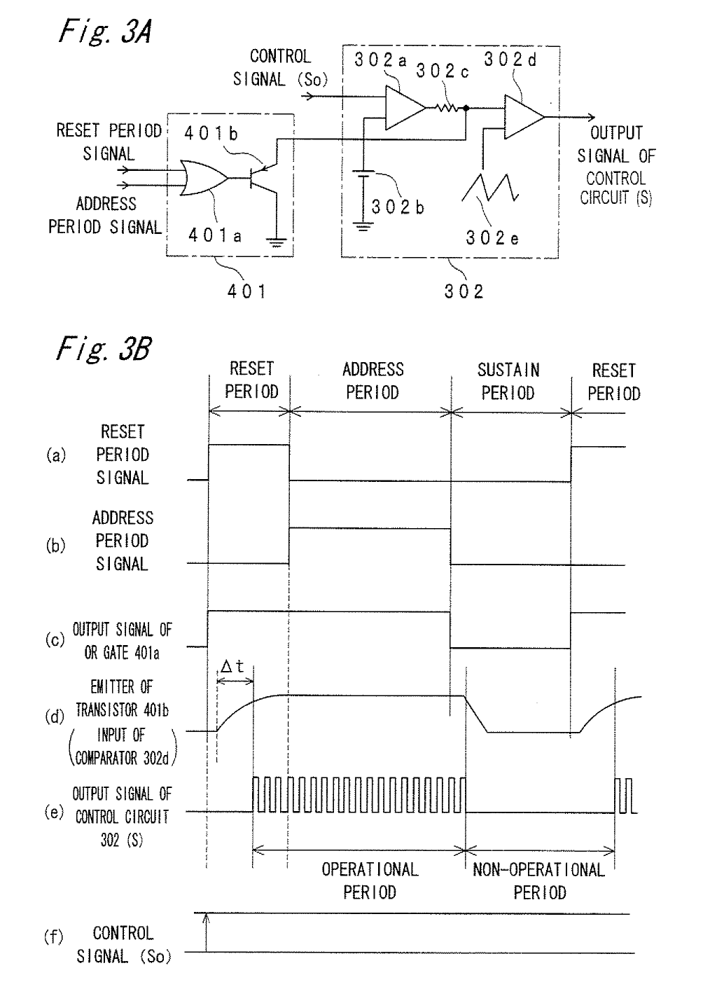

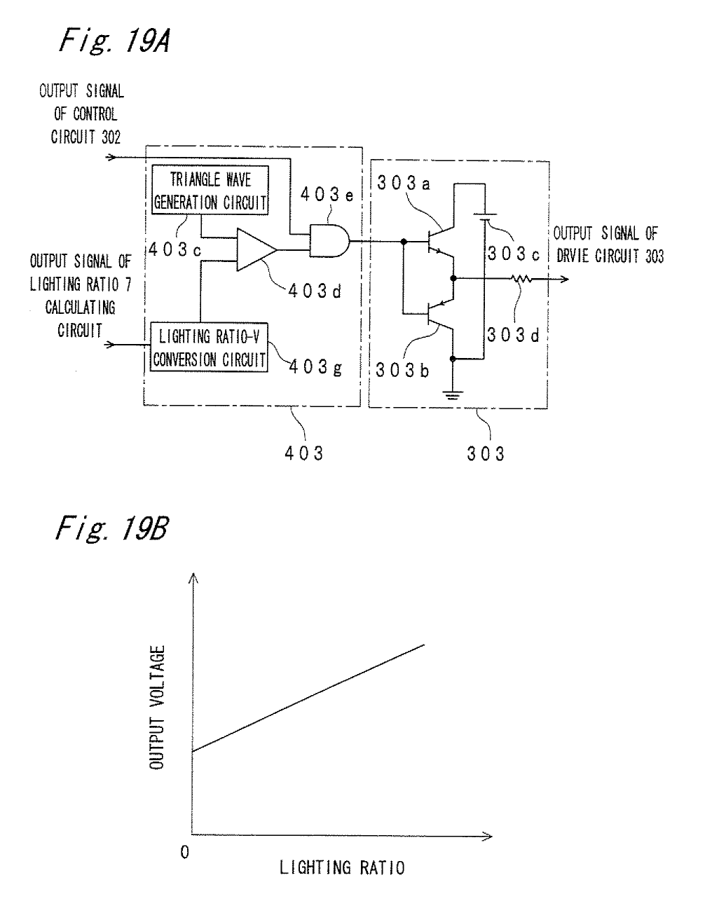

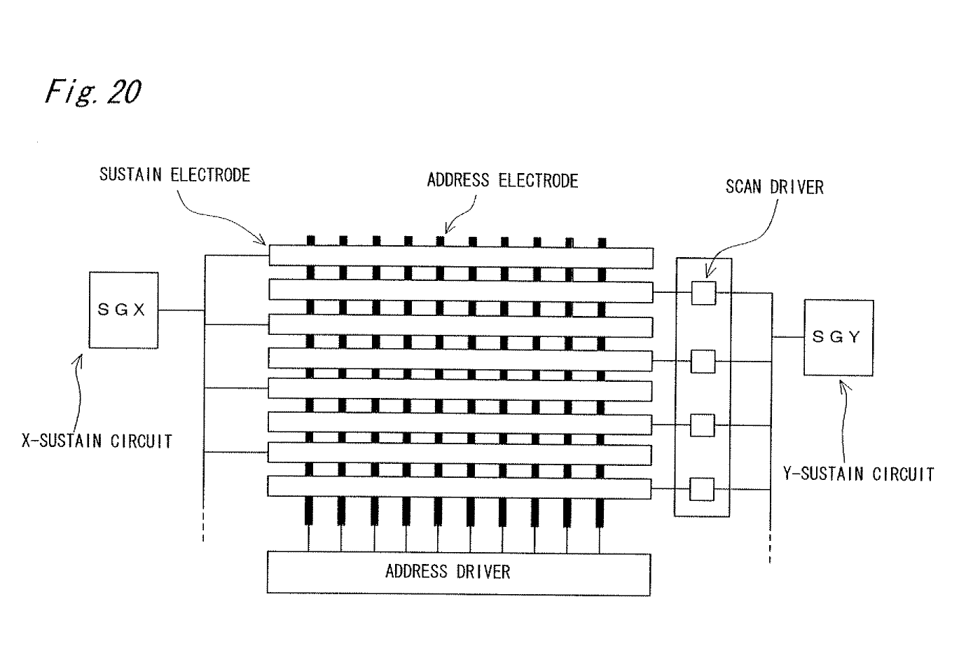

FIG. 3A shows specific configuration examples of the stop circuit 401 and a control circuit 302 for a power supply circuit necessary for an address period. The power supply circuit including the stop circuit 401 shown in FIG. 3A is a power supply circuit that supplies a necessary power during the address period (for example, a power supply circuit of −170V shown in FIG. 19) and operates only during the address period while stopping during the reset period and the sustain period.

As shown in FIG. 3A, the stop circuit 401 includes an OR gate 401a which inputs a reset period signal and a address period signal and a transistor 401b which is connected to the output of the OR gate 401a and is connected to the input of a comparator 302d. In the control circuit 302, the output of an operational amplifier 302a which inputs a reference voltage 302b and a control signal (S0) (the output voltage of the rectifier smooth circuit 306) is received by a comparator 302d via a resistor 302c. The comparator 302d compares the output of the operational amplifier 302a with a triangle wave 302e. It is noted that the output voltage of the rectifier smooth circuit 306 is used as a control signal (S0). When the output voltage of the rectifier smooth circuit 306 is low, the output voltage of the operational amplifier 302a increases, the output pulse width of the comparator 302d is made wider, and the output voltage of the rectifier smooth circuit 306 increases, so that the output voltage of the rectifier smooth circuit 306 is controlled to be constant.

FIG. 3B shows waveforms of a reset period signal, an address period signal, an output of an OR gate 401a, an emitter voltage of a transistor 401b, an output signal of the control circuit 302, and a control signal (S0) in the configuration shown in FIG. 3A. As shown in FIG. 3B, the output of the OR gate 401a is at “high” during the reset period and address period and at “low” during the sustain period. Therefore, during the sustain period, the transistor 401b turns on so as to cause one input of the comparator 302d to be 0V. Accordingly, the output pulse of the comparator 302d is stopped and the operation of the drive circuit 303 is stopped.

Since a switch 304 is turned off when the operation of the drive circuit 303 is stopped, a current does not flow through the primary winding and the secondary winding of a transformer 305, the switch 304, and the rectifier smooth circuit 306 during the almost reset and sustain periods. Therefore, during the non-operational (stop) period, conduction loss in the primary winding and the secondary winding of the transformer 305, the switch 304, and the rectifier smooth circuit 306, core loss of the transformer 305, switching loss of the switch 304, and the operational loss of the drive circuit 303 are reduced.

Although not illustrated in FIG. 3A, the emitter signal of the transistor 401b generates is delayed from rising edge of the reset period signal in FIG. 3B, because of capacitance components of a circuit for a countermeasure of false operation of the transistor 401b and a negative feedback circuit of the operational amplifier 302a. In addition, FIG. 3A shows an example of the stop circuit 401 and the control circuit 302, these circuits can be made by various circuits, and it is not limited to the disclosure. Further, the period signal is used for control operation and stop of a signal, however, the same operation can be made if using a signal which is synchronized with the period signal.

In addition, the output signal of the control circuit 302 is outputted in the middle of the reset period in FIG. 3B, because a delayed time Δt of the rising edge of the transistor 401b is considered. Outputting of the output signal of the control circuit 302 starts just before start of the address period so that outputting of the output signal of the control circuit 302 is always completed before start of the address period. Practically, it is intended that the control circuit 302 is operated only during the address period.

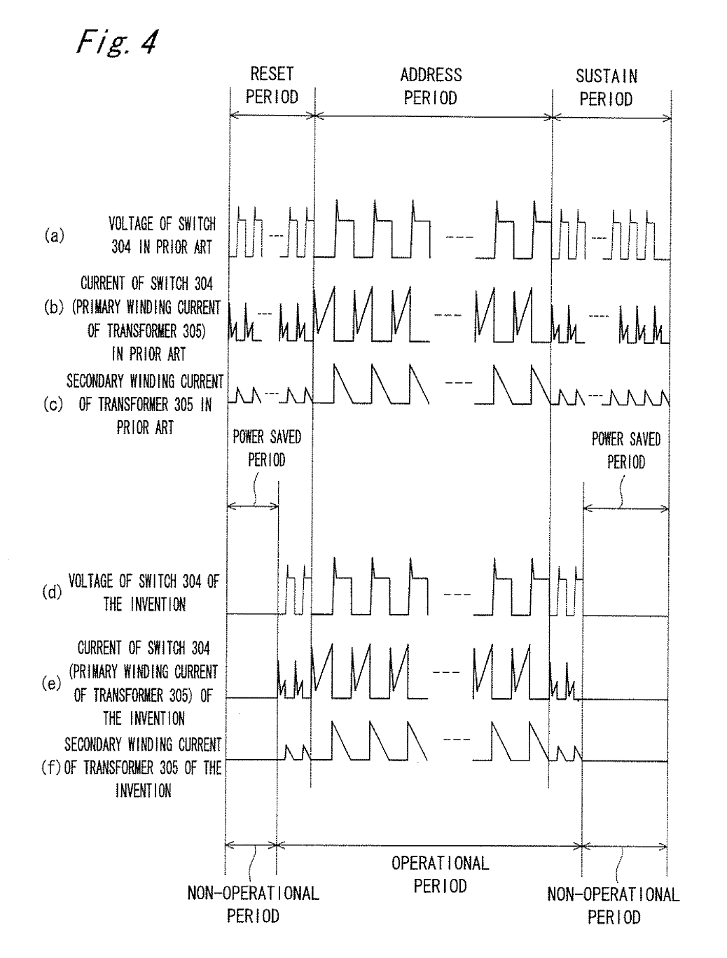

FIG. 4 is a view showing waveforms of a voltage and current of the switch 304, and a secondary winding current of the transformer 305 with the power supply circuit necessary for the address period having a ringing chalk converter (hereinafter, referred to as RCC) structure, comparing the prior art with the present invention. Generally, since the RCC system uses energy accumulated in the transformer 305, an ON period of the switch 304 becomes longer for a heavy load and shorter for a light load. An OFF period changes in the same way. As a result, the current pulse width of the switch 304 becomes wider since a power is supplied to the PDP electrode during the address period via the drive circuit 2. When the power supply circuit is always operated, it is not necessary to supply a power to the PDP electrode during the reset period and the sustain period, so that the current pulse width of the switch 304 is made narrower. However, although the power is not supplied to the PDP 1, a current with a high frequency continuously flows through the primary winding and the secondary winding of the transformer 305, the switch 304, and the rectifier smooth circuit 306, while the current peak value is lowered. Therefore, this current causes the conduction loss, the core loss of the transformer 305, the switching loss of the switch 304, and the operational loss of the drive circuit 303, in the primary winding and the secondary winding of the transformer 305, the switch 304, and the rectifier smooth circuit 306.

With reference to FIG. 2, FIG. 3A, FIG. 3B, and FIG. 4, one power supply circuit 3x necessary for the address period is explained, however, the above-described technical concept can be also applied to other period and it can be put into practice without a relation to the number of power supply circuits.

As described above, the PDP display device according to the first embodiment can reduce a power consumption in the power supply circuit by the power control circuit stopping the operation of the power supply circuits which are unnecessary for each waveform to be supplied to each electrode for an unnecessary period, without varying an oscillation frequency applied to the PDP of the high voltage and high frequency oscillation circuit disclosed in the patent document 1.

Accordingly, the PDP display device can be provided, which can reduce the power consumption in the PDP display device without lowering of the display luminance of the PDP and has excellent reliability in suppressing increase in temperature.

### Second Embodiment

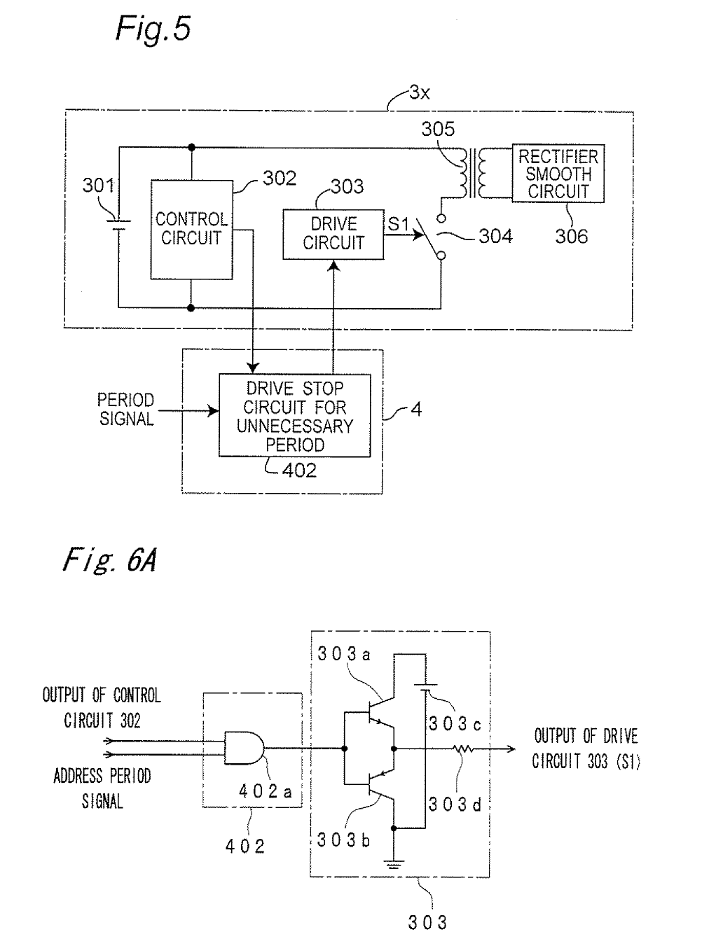

With reference to FIGS. 5 to 7, the second embodiment of the PDP display device according to the present invention will be described. The PDP display device according to the present embodiment has a difference in element to stop the operation in the power supply circuit from the first embodiment. Only the difference will be described below.

FIG. 5 shows configurations of a power supply circuit and a power control circuit of a PDP display device according to the second embodiment of the present invention.

According to the first embodiment, the stop circuit 401 stops the output pulse (S) of the control circuit 302. On the contrary, according to the present embodiment, as shown in FIG. 5, the power control circuit 4 includes a drive stop circuit for stopping drive for an unnecessary period, which can stop the output (S1) of the drive circuit 303.

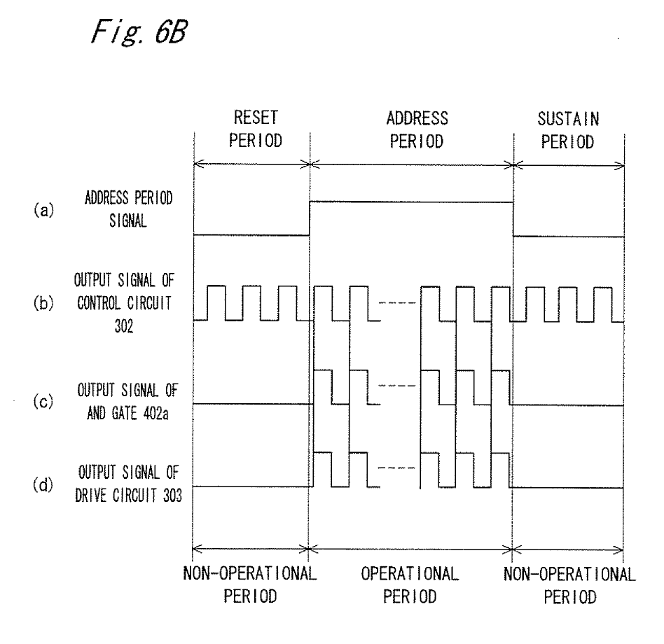

FIG. 6A is a view showing specific configuration of the drive stop circuit 402 for the power supply circuit necessary for an address period, and the drive circuit 303. As shown in FIG. 6A, the power control circuit 4 includes the AND gate 402a inputting the output signal of the control circuit 302 and an address period signal. The AND gate 402a passes the output signal of the control circuit 302 to bases of the transistor 303a and the transistor 303b of the drive circuit 303 only during the address period. When the output signal of the control circuit 302 is “high”, the transistor 303a is turned on to output a potential of a DC power supply 303c via a resistor 303d. When the output signal is “low”, the transistor 303b is turned on and the output of the drive circuit 303 becomes 0V.

FIG. 6B shows waveforms upon this operation. FIG. 6A shows an example of the drive stop circuit 402 and an example of the drive circuit 303. Those circuits can be made by various circuits and they are not limited to the disclosure.

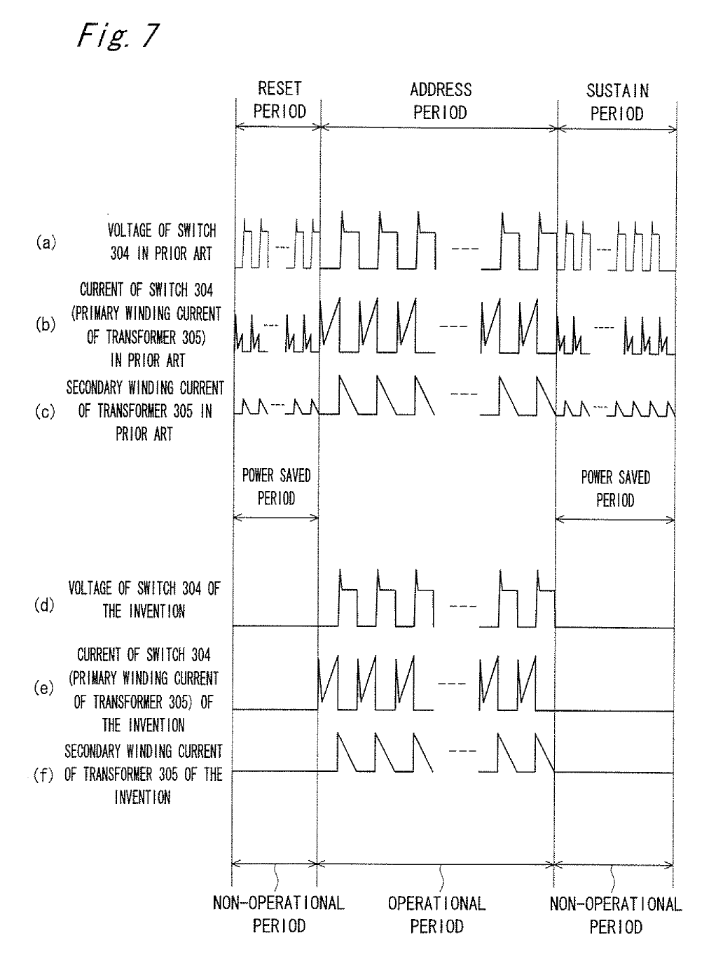

According to the first embodiment, since the input signal of the comparator 302d in the control circuit 302 is operated, a time delay is generated for the period signal. However, according to the present embodiment, the control circuit 302 is in the operational state and the input pulse is processed with TTL signal processing, so that no time delay is generated and a response at a high speed is possible. Thus, according to the present embodiment, the operation of the control circuit 302 is not stopped but a main current portion (the drive circuit 303 and the switch 304) is only stopped. Hence the operation can be achieved only for a necessary period, and non-operational period can be enlarged across the entire unnecessary period. As a result, as shown in FIG. 7, a current flows through the primary and secondary windings of the transformer 305, the switch 304, and the rectifier smooth circuit 306 only during the address period, and the current does not flow during the reset and sustain periods.

Accordingly, during the non-operational period, the conduction losses due to the primary and secondary windings of the transformer 305, the switch 304, and the rectifier smooth circuit 306; the core loss of the transformer 305; switching loss of the switch 304; and the operational loss of the drive circuit 303 are reduced.

<Variation>

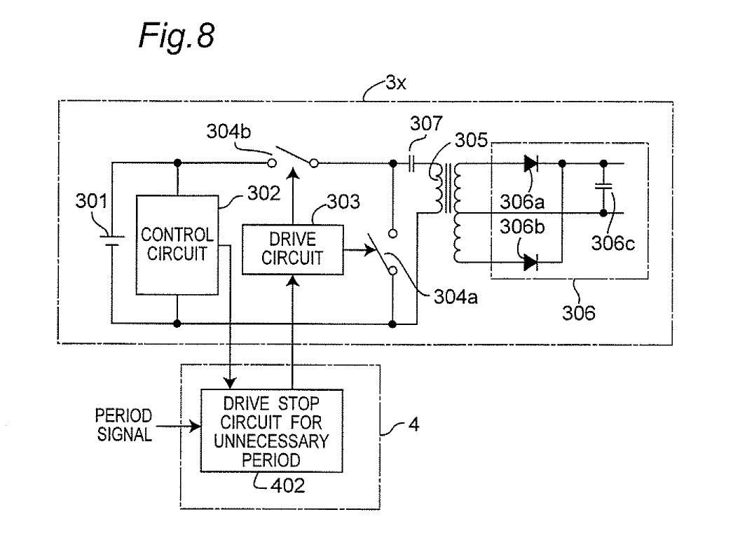

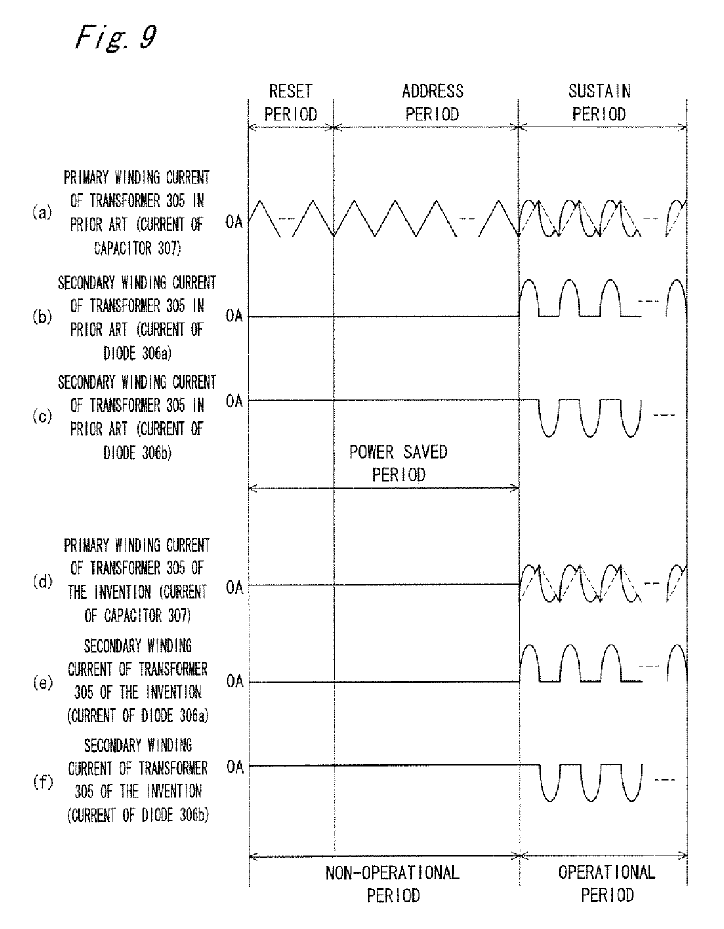

With reference to FIG. 8 and FIG. 9, other configuration example of the PDP display device according to the present embodiment explained with reference to FIGS. 5 to 7 will be explained.

FIG. 8 is a block diagram showing specific configurations of a power supply circuit and a power control circuit when the power supply circuit has a current resonance circuit configuration. FIG. 9 is a view showing waveforms of the primary winding current and the secondary winding current of the transformer 305 when the power supply circuit necessary for the sustain period has a half bridge current resonance circuit configuration, comparing the conventional art with the present invention.

It is a power supply circuit for sustaining and discharging the PDP 1 during the sustain period that is required for supplying the highest power among the power supply circuits for supplying power to the PDP 1. As the structure of this power supply circuit, a resonance circuit system and a regenerative system which are the circuits for high power with high efficiency, are used in many cases. The power supply circuit 3x shown in FIG. 8 has a half bridge and current resonance circuit configuration. The maximum output power is decided by a primary winding inductance of the transformer 305 and the excitation current of this. Turn-on of the switch 304b excites the primary winding of the transformer 305 and turn-on of the switch 304a excites inversely the primary winding of the transformer 305. With a load applied, a resonance current of a leak inductance of the transformer 305 and the capacitor 307 flows through a diode 306a and a diode 306b via the secondary winding of the transformer 305, and charges the capacitor 306c to be supplied to the load. The switch 304a and the switch 304b perform zero-voltage switching and the diode 306a and the diode 306b turn on and off zero current, thus resulting so that this power supply circuit operates much efficiently.

However, in the case that the power supply circuit always operates as shown in FIG. 9, the excitation current continuously flows through the switch 304a, the switch 304b, the capacitor 307, and the primary winding of the transformer 305 even if there is no load applied. Therefore, due to the current, the conduction loss, the core loss of the transformer 305, and the operational loss of the drive circuit 303 are generated in the switch 304a, the switch 304b, the capacitor 307, and the primary winding of the transformer 305. Further, since the excitation current is set at the maximum output power, the excitation current becomes large, and the core size of the transformer 305 becomes also large due to high power. As s result, the conduction loss and the core loss become also large with no load applied.

According to the present embodiment, since the output pulse of the drive circuit 303 can be operated and stopped at a high speed by the drive stop circuit 402, it is possible to allow the entire reset period and address period to be a non-operational period. In addition, a ratio of the sustain period to one subfield changes from about 1 to 70% and the ratio to one field changes from 20 to 50 in average. Accordingly, 50 to 80% of the entire period can be controlled to be non-operational period. Hence the conduction loss due to the switch 304a, the switch 304b, the capacitor 307, and the primary winding of the transformer 305, the core loss of the transformer 305, and the operational loss of the drive circuit 303, which are generated when the power supply circuit always operates, are reduced.

As described above, the PDP display device according to the present embodiment, as well as the first embodiment, can reduce a power to be consumed in the power supply circuit, by the power control circuit stopping the operation of the power supply circuits which are not necessary for waveforms to be supplied to electrodes for a period, without varying an oscillation frequency to be applied to the PDP by a high voltage and high frequency oscillation circuit disclosed by the patent document 1.

Accordingly, the PDP display device can be provided, which can reduce the power consumption in the PDP display device without lowering of the display luminance of the PDP and has excellent reliability in suppressing increase in temperature.

### Third Embodiment

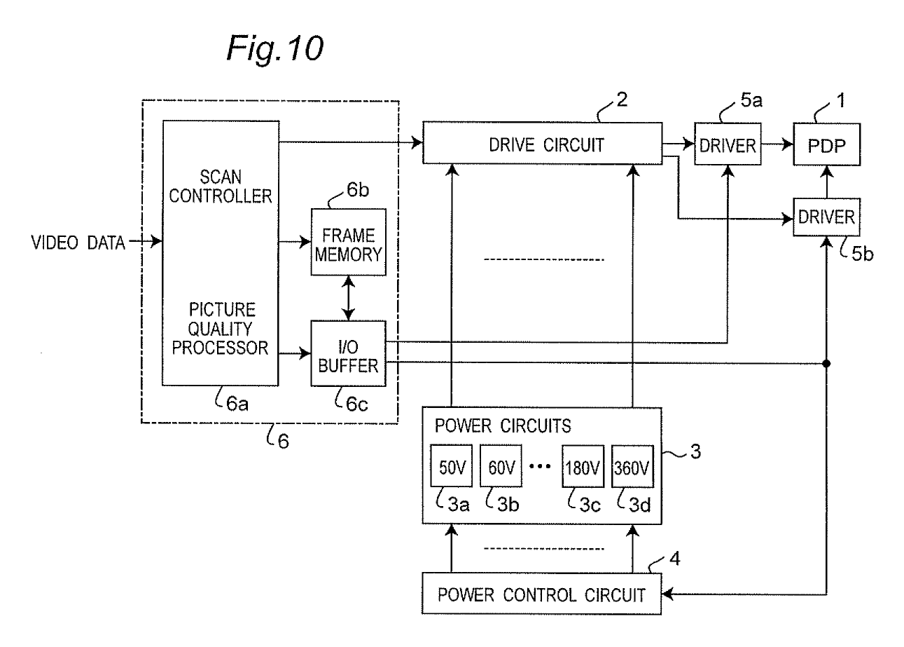

With reference to FIGS. 10 to 15, a third embodiment of the PDP display device according to the present invention will be described.

In the present embodiment, the output of the power supply circuit is adjusted in accordance with the emission state of the PDP 1, namely, the amount of power necessary for driving the PDP 1. In the present embodiment, the operation during the sustain period will be described.

FIG. 10 is a block diagram of a PDP display device according to the third embodiment. The PDP display device is composed of a PDP 1; a drive circuit 2 for generating a driving waveform corresponding to each period and applying it to the electrode of the PDP 1 via a scan driver 5a and an address driver 5b; a power supply circuit group 3 including a plurality of power supply circuits for supplying a power to the PDP 1 via the drive circuit 2; a power control circuit 4 for controlling the supply power to the PDP 1 by operating and stopping the power supply circuit group 3; the scan driver 5a; the address driver 5b; and a video processing circuit 6 for processing the video information and sending a signal to the drive circuit 2, the scan driver 5a and the address driver 5b.

The video processing circuit 6 is composed of a video processing section 6a including a scan controller for carrying out scanning and a picture quality processor for carrying out video processing; a frame memory 6b for storing a video signal once; and an I/O buffer 6c for sending a driving signal to the address driver 5b and the scan driver 5a in accordance with the address operation of each subfield.

In accordance with the address operation of each subfield, drive signals of the address driver 5b and the scan driver 5a are generated by the I/O buffer 6c from the video information stored in the frame memory 6b. Upon reception of this drive signal, the scan driver 5a and the address driver 5b apply a drive waveform generated by the drive circuit 2 as shown in FIG. 19 to each electrode of the PDP 1. An address electrode to which a pulse is applied during the address period of the drive waveform becomes an address electrode which is selected for emission. As a result, the address period of the drive signal sent from the I/O buffer 6c to the address driver 5b includes the same number of pulses as the electrodes selected for emission.

According to the present embodiment, on the basis of the drive signal of the address driver 5b, the output of the power supply circuit necessary for the sustain period is stopped.

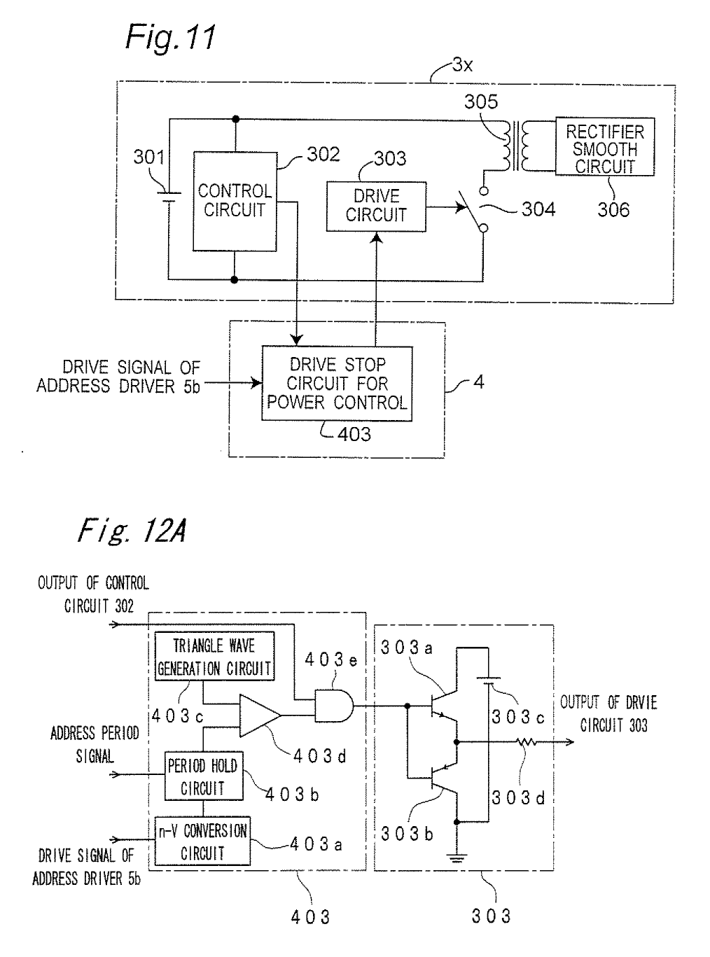

FIG. 11 is a view showing specific configurations of a power supply circuit and a power control circuit. A control circuit 302 outputs a drive signal for controlling the switching operation of a switch 304 in order to obtain an output voltage inherent to respective power supply circuits 3a, 3b, . . . . A signal made by superimposing an output signal of a comparator 403d on the output signal of the control circuit 302 is applied to the switch 304. A power control circuit 4 includes a drive stop circuit 403 for power control. The drive stop circuit 403 stop the output of a drive circuit 303 of a power supply circuit 3x which is necessary for sustaining and discharging the PDP 1 during the sustain period.

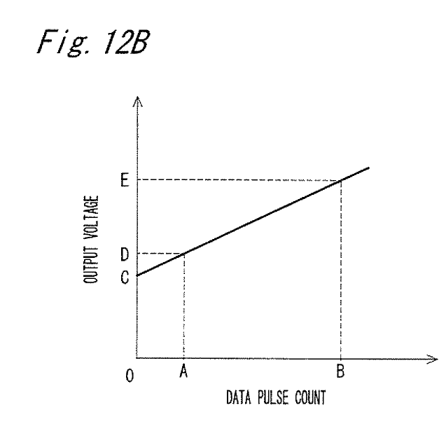

FIG. 12A is a view showing specific examples of the drive stop circuit 403 and the drive circuit 303. In the drive stop circuit 403, upon receipt of a drive signal of an address driver 5b, an n-V conversion circuit 403a generates an output voltage in accordance with the number of data pulse during the address period in accordance with a property shown in FIG. 12B. A period hold circuit 403b holds the output voltage during one cycle from a falling to the next falling of a address period signal, namely, during one subfield. A triangle wave generation circuit 403c generates a triangle wave with a fixed period longer than the oscillation period (the driving period) of the power supply circuit 3x. The reason why the period of the triangle wave is set in that way is because one period (T) including a non-operational period and an operational period of the power supply circuit 3x to be described later is made longer than one period (t) of the control signal of the power supply circuit 3x. The comparator 403d compares the output voltage held by the period hold circuit 403b with the output of the triangle wave generation circuit 403c to output a pulse in accordance with a comparison result. This output pulse and the output signal of the control circuit 302 are inputted into an AND gate 403e. Only when the output pulse of the comparator 403d is ON, the output signal of the control circuit 302 is outputted to the drive circuit 303.

The drive circuit 303 outputs the same pulse as the inputted pulse. When the output pulse of the comparator 403d is OFF, the drive circuit 303 is stopped so that no current flows through the primary winding and the secondary winding of the transformer 305 of the power supply circuit 3, the switch 304, and a rectifier smooth circuit 306.

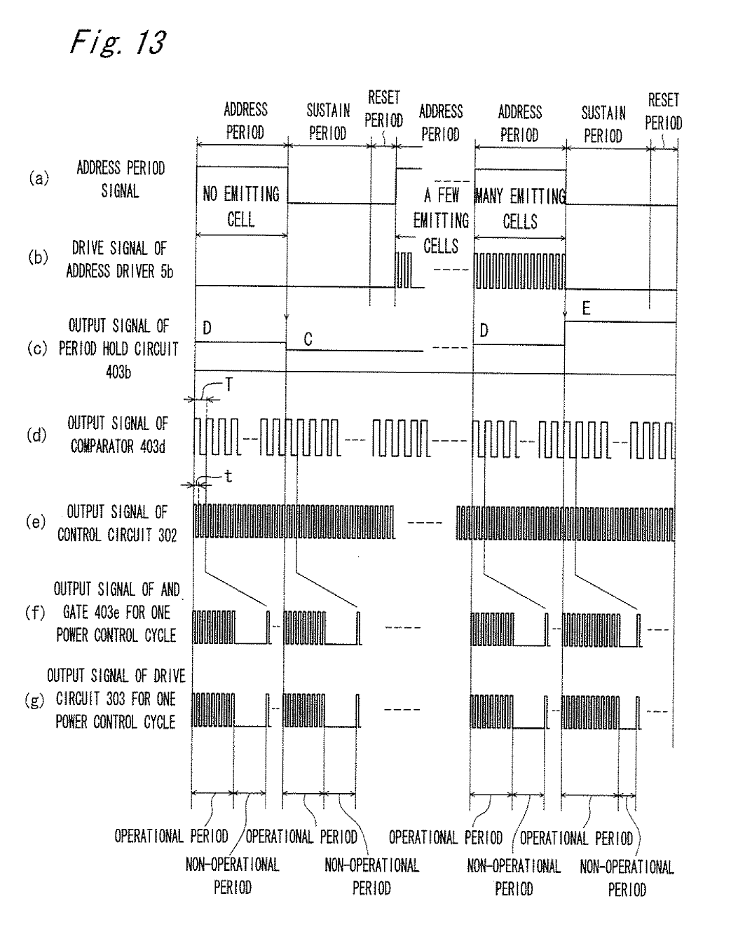

FIG. 13 shows an operational waveform in the above-described case. When there is no cell to be emitted, namely, when there is no pulse included in the drive signal of the address driver 5b, the lowest output voltage C is outputted in the property shown in FIG. 12B. Therefore, the ON period of the output pulse of the comparator 403d is made shorter, the operational period of the drive circuit 303 is made shorter, and the non-operational period is made longer. As a result, a power for charging a capacitor (not shown) in the rectifier smooth circuit 306 of the power supply circuit 3 is decreased. However, since the PDP 1 to be a load is not emitted, the power discharged from the capacitor in the rectifier smooth circuit 306 due to power supply to the PDP 1 is also decreased, so that there is no decrease of the output voltage of the power supply circuit 3.

On the other hand, when there are many cells to be emitted, namely, when there is a large number of pulses included in the drive signal of the address driver 5b (when the number of pulse is B), a voltage E is outputted according to a property shown in FIG. 12B, so that the on period of the output pulse of the comparator 403d is made longer; the operational period of the drive circuit 303 is made longer; and the non-operation period is made shorter. In this case, since the PDP 1 to be a load has many emission cells, the power discharged from the capacitor in the rectifier smooth circuit 306 due to power supply to the PDP 1 is increased. However, a power for charging the capacitor in the rectifier smooth circuit 306 of the power supply circuit 3 is also increased, and thus output voltage of the power supply circuit 3 is not decreased. In addition, also when there are few cells to be emitted, namely, also when there is a small number of pulses included in the drive signal of the address driver 5b (when the number of pulse is A), a voltage D is outputted according to a property shown in FIG. 12B, the non-operational period is changed due to the same operation as the above, and the power from the power supply circuit 3 is changed.

It is noted that, as described in the first embodiment, the power supply circuit 3x itself is controlled by the control circuit 302 to keep the output voltage of the rectifier smooth circuit 306 constant.

Since it is possible to control power supply from the power supply circuit 3 to the PDD 1 in accordance with the number of data pulses of the address period, namely, the emission state of the PDP 1 in this manner, it is possible to supply only a power necessary for each subfield. That is, when a required power supply is small, the non-operational period of the power supply circuit 3 can be made longer, and thus it is possible to largely reduce conduction loss due to the primary winding and the secondary winding of the transformer 305, the switch 304, and the rectifier smooth circuit 306, core loss of the transformer 305, switching loss of the switch 304, and the operational loss of the drive circuit 303.

When the size of the PDP 1 is large, the power of the power supply circuit for sustaining and discharging the PDP 1 is made larger and the transformer 305 of the power supply circuit is made also larger. In this case, repetition of operation (driving) and stop of the power supply circuit 3 controlled by the power control circuit 4 generates an oscillation sound of the transformer 305. This problem can be solved by setting a repetition frequency of operation and stop of the power supply circuit 3 at a predetermined value not less than an audible frequency.

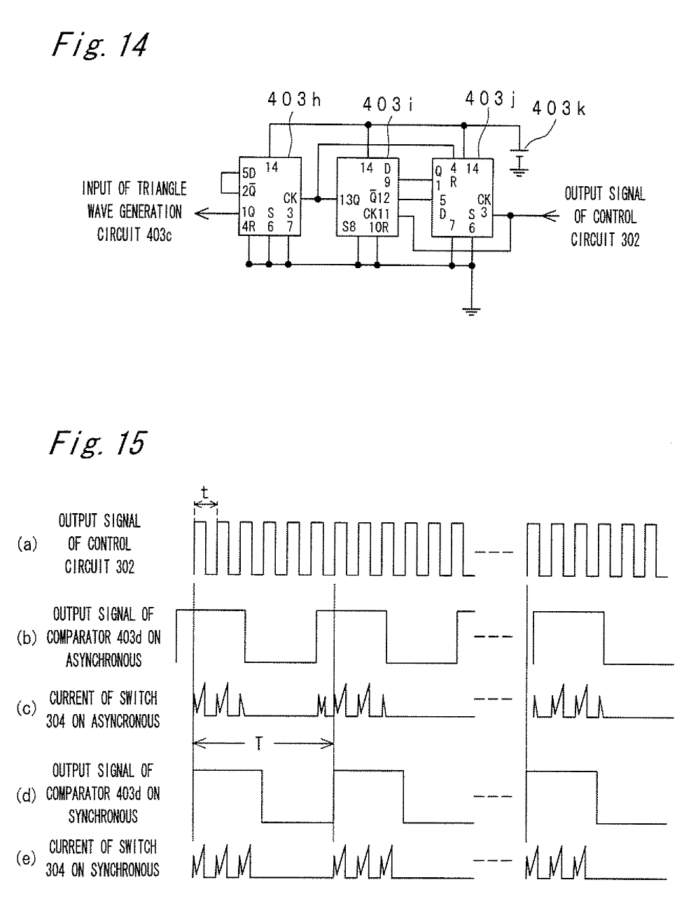

In addition, when an operation start phase of the power supply circuit 3 changes at a difference frequency between a repetition frequency of operation and stop of the power supply circuit 3 by the power control circuit 4 and an oscillation frequency of the power supply circuit 3 (a driving frequency), the oscillation sound of the transformer 305 may be generated. This problem can be solved by synchronizing the repetition frequency of operation and stop of the power supply circuit 3 by the power control circuit 4 with the oscillation frequency of the power supply circuit 3 (namely, the frequency of the output signal of the control circuit 302). In addition, it is preferable to set the repetition frequency of operation and stop of the operation of the power supply circuit 3 due to the power control circuit 4 at 1/n (n is a positive integer number) of the oscillation frequency of the power supply circuit 3. In order to realize the above, for example, a synchronous circuit is inserted between the control circuit 302 and the drive stop circuit 403. FIG. 14 shows an example of a synchronous circuit using a frequency divider. The synchronous circuit is composed of an RS flip flops 403h, 403i and 403j and a direct current power supply 403k. Due to the synchronous circuit, the repetition frequency of operation and stop of the power supply circuit 3 by the power control circuit 4 is synchronized with the oscillation frequency of the power supply circuit 3 to be the frequency, which is ⅙ of the oscillation frequency. FIG. 15 is a view explaining a waveform of a current flowing through the switch 304 when the repetition frequency of operation and stop of the power supply circuit 3 by the power control circuit 4 is not or is synchronized with the oscillation frequency of the power supply circuit 3. BY synchronizing them, the operation start phases of the power supply circuit 3 by the power control circuit 4 become same (refer to FIGS. 15D and 15E), the start waveforms of the current of the switch 304 become same. As a result, the generation of the oscillation sound of the transformer 305 with the difference frequency is reduced. FIG. 14 only shows an example of the synchronous circuit and the present embodiment can be applied to other circuit.

In addition, the oscillation sound of the transformer 305 with the difference frequency becomes the audible sound since the difference frequency is constant. As a result, by carrying out the repetition of operation and stop of the power supply circuit 3 by the power control circuit at a random frequency (namely, a frequency that is always changed at random), the difference frequency with the oscillation frequency of the power supply circuit 3 also becomes the random frequency, thereby resulting in no sound. The random frequency can be generated by superimposing a white noise on the triangle wave generation circuit 403c, for example.

<Variation 1>

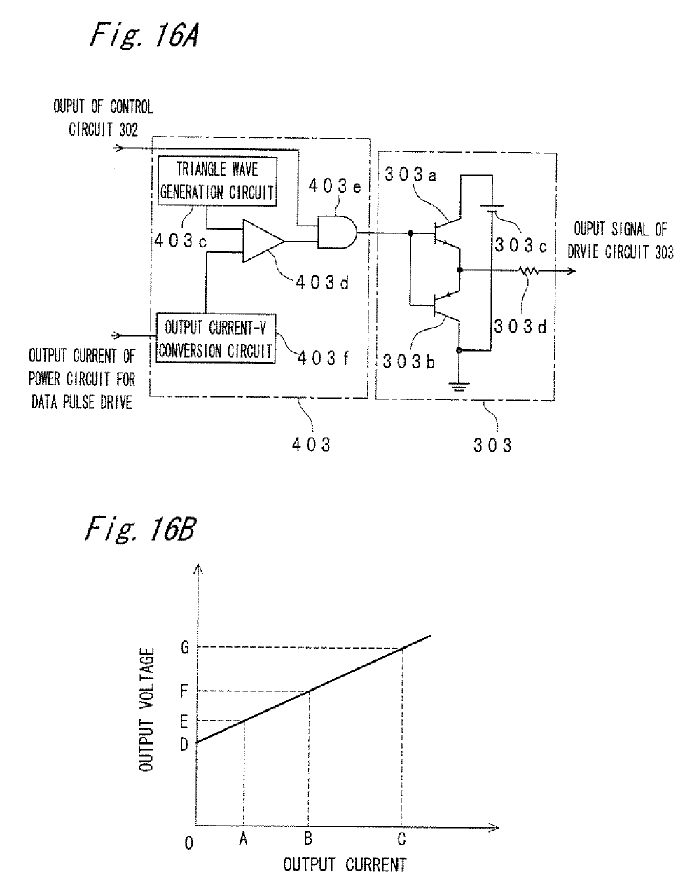

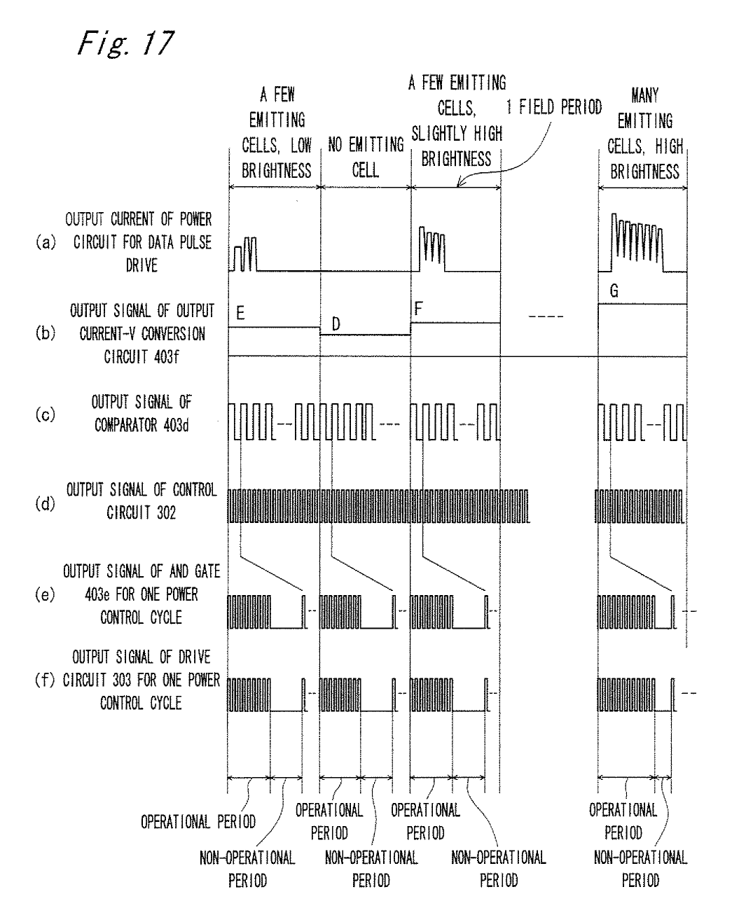

Here, other configuration example of the PDP display device according to the present embodiment will be described with reference to FIG. 16A, FIG. 16B, and FIG. 17. In the example to be described below, the drive stop circuit 403 controls operation/stop of the power supply circuit 3x based on the output current of the power supply circuit 3 for driving a data pulse.

In the above-described example as shown in FIG. 10, the power control circuit 4 controls operation/stop of the power supply circuit group 3 with the drive signal to the address driver 5b. On the contrary, in the other example, the operation/stop of the power supply circuit group 3 is controlled based on the output current of the power supply circuit for driving a data pulse 3. As described in the above-described example, based on the video information, a drive signal is sent from an I/O buffer 6c to an address driver 5b. The address driver 5b supplies the power supplied from the power supply circuit 3 for driving a data pulse via a drive circuit 2, to an address electrode selected by the drive signal. Accordingly, this results in that the power only for the selected address electrode is supplied from the power supply circuit 3 for driving a data pulse. In this way, stopping the output of the drive circuit 303 of the power supply circuit 3 for sustaining and discharging the PDP 1 allows the supply power to be minimum.

FIG. 16A is a view showing specific configuration of a drive stop circuit for power control and a drive circuit according in the other example.

An output current-V conversion circuit 403f inputs the output current value of the power supply circuit 3 for driving a data pulse. The output current-V conversion circuit 403, as shown in FIG. 16B, outputs a voltage in accordance with the output current value of the power supply circuit 3 for driving a data pulse. The output of the output current-V conversion circuit 403f is compared with the output of a triangle wave generation circuit 403c by a comparator 403d, and then, a pulse is outputted. This output pulse and the output signal of a control circuit 302 are inputted in an AND gate 403e, and only when the output pulse of the comparator 403d is ON, the output signal of the control circuit 302 is outputted to the drive circuit 303. The drive circuit 303 outputs the same pulse as the inputted pulse.

When the output pulse of the comparator 403d is OFF, the operation of the drive circuit 303 is stopped, so that no current flows through the primary and secondary windings of the transformer 305 of the power supply circuit 3 for a data pulse, the switch 304, and a rectifier smooth circuit 306. FIG. 17 shows an operational waveform of this case. Due to increase and decrease of the output current value of the power supply circuit 3 for a data pulse, the output voltage of the output current-V conversion circuit 403f changes to D, E, F and G so as to change the non-operational period of the drive circuit 303.

The output current of the power supply circuit for driving a data pulse can be detected by a resistance and a current sensor or the like. As a result, since the supply power from the power supply circuit 3 to the PDP 1 can be controlled in accordance with the emission state of the PDP 1 as same as the above-described example, the necessary power can be only controlled. Therefore, when there is a little necessary supply power, the non-operational period of the power supply circuit 3 can be made longer, so that it is possible to largely reduce conduction loss due to the primary and secondary windings of the transformer 305, the switch 304, and the rectifier smooth circuit 306, core loss of the transformer 305, switching loss of the switch 304, and the operational loss of the drive circuit 303.

<Variation 2>

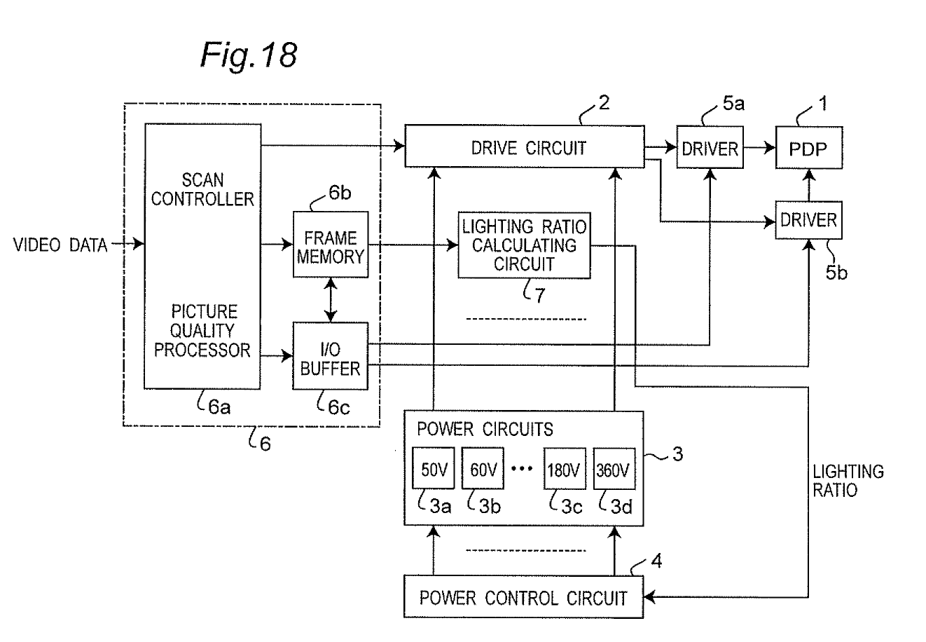

Another example of the PDP display device according to the present embodiment will be described with reference to FIG. 18, FIG. 19A, and FIG. 19B.

According to another example, a drive stop circuit 403 for power control controls operation/stop of the power supply circuit 3x on the basis of the video information which is related to a picture to be displayed and stored in the frame memory 6b.

FIG. 18 is a block diagram of a PDP display device according to another example. The PUP display device is provided with a lighting ratio calculating circuit 7 in addition to the configuration shown in FIG. 10. The lighting ratio calculating circuit 7 calculates a lighting ratio of the PDP 1 with respect to a picture to be displayed, from the video information which is related to a picture to be displayed and stored in the frame memory 6b. A power control circuit 4 controls operation/stop of a power supply circuit group 3 on the basis of the lighting ratio calculated by the lighting ratio calculating circuit 7. Thus, the PDP 1 is arranged so as to stop output of a drive circuit 303 of a power supply circuit 3 for sustaining and discharging the PDP 1 on the basis of the lighting ratio of the PDP 1 at a picture before display. Hence, it is possible to suppress the supply power to the minimum power.

FIG. 19A is a view showing specific configuration examples of a drive stop circuit 403 for power control and the drive circuit 303. FIG. 19B is a view showing a relation between a lighting ratio and the output of a lighting ratio-V conversion circuit 403g in FIG. 19A.

In FIG. 19A, the lighting ratio-V conversion circuit 403g inputs an output signal indicating a lighting ratio from the lighting ratio calculating circuit 7, and outputs a voltage in accordance with the lighting ratio as shown in FIG. 19B. The output voltage of the lighting ratio-V conversion circuit 403g is compared with the output of a triangle wave generation circuit 403c by a comparator 403d, and then a pulse is outputted. This output pulse and the output signal of the control circuit 302 are inputted in an AND gate 403e. Only when the output pulse of the comparator 403d is ON, the output signal of the control circuit 302 is outputted to a drive circuit 303. The drive circuit 303 outputs the same pulse as the inputted pulse.

When the output pulse of the comparator 403d is OFF, the drive circuit 303 is stopped so that a current does not flow through the primary and secondary windings of the transformer 305 of the power supply circuit 3, the switch 304, and a rectifier smooth circuit 306.

As described above, the output voltage of the lighting ratio-V conversion circuit 403g changes depending on increase and decrease of the lighting ratio so as to change the non-operational period of the drive circuit 303. As a result, as same as the above-described embodiment, since the supply power from the power supply circuit 3 to the PDP 1 can be controlled in accordance with the emission state of the PDP 1, only the necessary power can be supplied. Therefore, the non-operational period of the drive circuit 303 can be made longer when a necessary supply power is little, and it is possible to largely reduce conduction loss due to the primary and secondary windings of the transformer 305, the switch 304, and the rectifier smooth circuit 306; core loss of the transformer 305; switching loss of the switch 304; and the operational loss of the drive circuit 303. The output voltage of the lighting ratio-V conversion circuit 403g is outputted with a delay so as to be synchronized with the display period of the PDP 1.

As described above, also according to the PDP display device of the present embodiment as same as the first embodiment, it is possible to reduce the power to be consumed in the power supply circuit by the power control circuit stopping the power supply circuit in accordance with the emission state of the PDP, without varying of the oscillation frequency of the high voltage and high frequency oscillation circuit to be applied to the PDP disclosed in the patent document 1.

Accordingly, the PDP display device can be provided, which can reduce the power consumption in the PDP display device is without lowering of the display luminance of the PDP and has excellent reliability in suppressing increase in temperature.

The present invention has been described with respect to specific embodiments, however, it is obvious for a person skilled in the art to use many other modified examples, alternation, and others. Therefore, the present invention is not limited to specific disclosures herein but is only limited to the attached claims. The present application is related to Japanese Patent Application, JP-A-2004-116520 (filed on Apr. 12, 2004), the content of which is incorporated herein by reference.

### INDUSTRIAL APPLICABILITY

The PDP display device according to the present invention reduces power consumption in the PDP display device, has excellent reliability in suppressing increase in temperature, so than the PDP display device according to the present invention is useful for a PDP display apparatus.

1. A plasma display panel display device comprising:
a plasma display panel having a plurality of electrodes;
a drive circuit that supplies a driving waveform to the electrode;
a power supply circuit that includes a transformer or inductor, a switch to intermittently apply a power supply voltage to the transformer or inductor, and a controller that outputs a control pulse to control operation of the switch; and
a power control circuit that includes a drive stop circuit that stops the output of the control pulse, and adjusts output power capable of being supplied to electrodes of the plasma display panel by controlling a ratio of non-operational period to operational period oft power supply circuit based on emission state of the plasma display panel by the drive stop circuit.

2. The plasma display panel display device according to claim 1, wherein the drive stop circuit masks the control pulse with a signal having a different period from the control pulse and a pulse width controlled based on the emission state to change the ratio of non-operational period to operational period of the power supply circuit.

3. The plasma display panel display device according to claim 2, wherein, when the power supply circuit is configured in a switching system, one period including the non-operational period and the operational period of the power supply circuit controlled by the power control circuit is longer than one cycle of the switching operation of the power supply circuit.

4. The plasma display panel display device according to claim 3, wherein the operation and stop of the power supply circuit by the power control circuit are repeated at a random frequency.

5. The plasma display panel display device according to claim 3, wherein the operation and stop of the power supply circuit by the power control circuit is repeated at a constant frequency.

6. The plasma display panel display device according to claim 5, wherein the frequency for the repetition of operation and stop of the power supply circuit by the power control circuit is not less than an audible frequency.

7. The plasma display panel display device according to claim 6, wherein the frequency for the repetition of operation and stop of the power supply circuit by the power control circuit is synchronized with a driving frequency of the power supply circuit.

8. The plasma display panel display device according to claim 7, wherein the frequency for the repetition of operation and stop of the power supply circuit by the power control circuit is 1/n of a driving frequency of the power supply circuit (n is a positive integer).

9. (canceled)

10. The plasma display pane panel display device according to claim 1, wherein the power control circuit adjusts the output power based on video information to be displayed.

11. The plasma display panel display device according to claim 1, wherein the power control circuit adjusts the output power based on the number of data pulses which are included in an address period.

12. The plasma display panel display device according to claim 1, wherein the power control circuit adjusts the output power based on the output voltage of a power supply circuit for driving a data pulse.

13. The plasma display panel display device according to claim 1, wherein the power control circuit adjusts the output power based on video information to be displayed, which is stored in a frame memory.

14. The plasma display panel display device according to claim 1, wherein the power supply circuit is configured in a resonance system or a regenerative system.
